(19) United States
(12) Patent Application Publication
(10) Pub. No.: US 2014/0278466 A1
(43) Pub. Date: Sep. 18, 2014

(54) PHARMACY WORKFLOW

(71) Applicant: CVS Pharmacy, Inc., Woonsocket, RI (US)

(72) Inventors: Peter D. Simmons, Medway, MA (US); Lorna A. Danko, Cumberland, RI (US)

(73) Assignee: CVS Pharmacy, Inc., Woonsocket, RI (US)

(21) Appl. No.: 13/836,820

(22) Filed: Mar. 15, 2013

(51) Int. Cl. G06F 19/00

(52) U.S. Cl. CPC G06F 19/3456
USPC 705/2

(57) ABSTRACT

A method for managing workflow in a pharmacy includes receiving a pharmaceutical prescription and assigning to it a priority and a time at which the prescription is to be filled. The prescription and assigned information are entered into a first “triage queue”; high-priority prescriptions are selected from this queue for filling. These prescriptions may then be entered into a second “production queue.”

### TECHNICAL FIELD

Embodiments of the present invention relate to merchant workflow and, more particularly, to systems and methods for managing the filling of prescriptions for prescribed drugs or pharmaceuticals.

### BACKGROUND

Pharmacies provide customers with many different ways to fill and refill their pharmaceutical prescriptions—from online requests and telephone calls to in-person drop-off and drive-through requests. Prescribers may also initiate prescriptions by contacting pharmacies via on-line requests, faxes, telephone calls, use of voicemail and mailing prescriptions. Each of these requests may have different constraints: some customers may have an acute medical need to receive a prescribed drug very quickly, for example, while others may be refilling an unexpired, existing prescription and thus have no such acute medical need. Some customers may be placing an order for later pick-up, while others may be waiting in the pharmacy for their order. Some customers may order a single prescription, while others may order multiple prescriptions and wish to pick them all up at the same time. The prescriptions themselves may further introduce constraints: the pharmacy may be out of stock of a particular drug, for example, or may need to confirm or clarify a prescription with a doctor and/or gain approval for payment from a third-party payor.

Mismanagement of these constraints may lead to dissatisfied customers. A customer waiting in-store, for example, may need to leave if a prescription is not filled in a given period of time, thus requiring a return visit. Likewise, if every drug in a multiple-prescription order is not ready at the same time, a customer may need to make a follow-up visit to collect the missing drugs(s).

Existing systems and methods apply an ad hoc solution to prescription management wherein prescriptions received from different input channels and/or different technicians may be assigned different, often conflicting priorities. A first technician at a pharmacy counter may, for example, flag a prescription as high priority at the same time a second technician at a drive-through window also flags a different prescription as high priority. Without any way to differentiate between them, a pharmacy technician may fill the two prescriptions in any order (as determined by, for example, the order in which they are received from the first and second technicians), which may lead to a non-optimal result—the in-store customer may have a more pressing need, for example, but the drive-through order may be filled first. A need therefore exists for a comprehensive way to assess the priorities of all or most prescriptions arriving at a pharmacy to thereby prioritize the prescriptions more optimally.

### SUMMARY

In general, various aspects of the systems and methods described herein relate to queue-based prioritization of prescriptions incoming to a pharmacy and the filling of said prescriptions in accordance with that priority. A first “triage queue” collects incoming prescriptions and assigns priorities thereto based on, for example, the type of drug in the prescription, channel by which the prescription arrived at the pharmacy, proximity of prescriber to the local pharmacy, or a pick-up time specifically requested by the customer having the prescription filled. High-priority prescriptions in the triage queue leave the queue for downstream processing (e.g., the filling and/or verification of the prescription). In one embodiment, the prescriptions leaving the triage queue are entered into a second “production queue” for processing via manual or automatic means. The triage queue prioritizes incoming prescriptions to ensure action is taken on prescriptions in order to process the prescriptions having the most urgent known or predicted need first and less-urgent prescriptions later. In addition to prescription fulfillment the triage queue may also prompt pharmacy personnel to contact patients to alert them to issues uncovered during their prescription that may affect the customer's expected pick-up time. In one embodiment, the triage queue has the flexibility to allow multiple users to access and process items simultaneously while maintaining priority order and/or to prevent multiple users from attempting to access the same prescription record at the same time. In one embodiment, approximately 30% of received prescriptions encounter a processing issue; the triage queue re-evaluates the priority of one or more prescriptions having issues based on new prescriptions that have entered the triage queue to determine what work should be completed next in order to meet customer expectations.

In one aspect, a method for managing workflow in a pharmacy includes receiving electronic data comprising a pharmaceutical prescription and storing the electronic data in a computer memory. A priority and a time at which the prescription is to be filled are assigned to the received pharmaceutical prescription based on the electronic data. A prescription having the highest priority is selected from a plurality of prescriptions, and the selected prescription is to be filled by the time is indicated to a user via an electronic display.

The electronic data may include an online data transmission, fax, or voicemail. Selecting the prescription may include entering the received prescription into a triage queue comprising other prescriptions. Assigning the time may include computing the time based on a type of drug indicated in the prescription. The drugs may be typed as acute or maintenance, and wherein acute drugs have a time occurring earlier than maintenance drugs. Assigning the time may include computing the time based on a channel from which the prescription was received. Assigning the time may include applying a time communicated from a customer or third party. Prescriptions may be received from in-store drop-off, drive-through drop-off, or a prescriber telephone call. The selected prescription may include an issue preventing its filling and is assigned a new priority or time.

In another aspect, a system for managing workflow in a pharmacy includes an input port for receiving data comprising a pharmaceutical prescription and a processor for executing instructions stored in a computer memory. The computer memory includes a queue manager module for assigning to the prescription, based on the received data, (i) a priority and (ii) a time at which the prescription is to be filled, a triage queue for storing a plurality of pending prescriptions each having a priority and a time at which it is to be filled, and a production queue for receiving, from the triage queue, a highest-priority prescription. A computer display indicates, to a user, that the received prescription is to be filled by its assigned time.

The computer memory may further include a verification queue for indicating which of a plurality of filled prescriptions is to be verified for correctness; a terminal may be used for entering the data comprising the prescription. The priority queue may include a triage time indicating a time at which the prescription leaves the triage queue.

Assigning the time may include computing the time based on a type of drug indicated in the prescription. The drugs may be typed as acute or maintenance; acute drugs may have a time occurring earlier than maintenance drugs. A storage device may store information related to the types of drugs.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. In the following description, various embodiments of the present invention are described with reference to the following drawings, in which:

FIG. 1 is a block diagram of a system of prioritization queues in accordance with an embodiment of the invention;

FIG. 2 is a block diagram of a triage queue in accordance with an embodiment of the invention;

FIG. 3 is an illustration of a triage queue in accordance with an embodiment of the invention;

FIG. 4 is a system for implementing pharmacy prioritization queues in accordance with an embodiment of the invention;

FIG. 5 is another illustration of a triage queue in accordance with an embodiment of the invention; and

FIG. 6 is a block diagram of a pharmacy workflow system in accordance with an embodiment of the invention.

### DETAILED DESCRIPTION

Described herein are various embodiments of methods and systems for managing the intake and filling of pharmaceutical prescriptions at a pharmacy. In one embodiment, as illustrated in FIG. 1, a system of queues 100 is used to prioritize and fill the prescriptions. A first “triage queue” 102 receives new prescriptions from one or more of a variety of sources; each new prescription is examined and assigned a priority based on, for example, information extracted from the prescription. High-priority prescriptions are assigned to the top of the triage queue 102, for example, while medium- or low-priority prescriptions are assigned lower positions in the triage queue 102. In one embodiment, as explained further below, the prescriptions are each assigned a triage time and are sorted by that time. Thus, as explained in greater detail below, all (or most) incoming prescriptions are assigned a priority relative to all (or most) other already pending prescriptions, thereby allowing a pharmacy to rank and prioritize a greater number of prescriptions more accurately. One or more actions may be executed on a prescription after it moves from the triage queue 102. For example, information contained in the prescription may be analyzed, translated, reformatted, and/or otherwise processed into a standard format suitable for downstream workflow processing; and conflicts or discrepancies in the information (e.g., a partial name mismatch, a spelling error, or illegible or incomplete information) may be resolved. In various embodiments, these actions are carried out by a data-entry technician, automatically by a computer, or any combination thereof. The patient may be contacted to resolve or verify some or all of this information and, as explained further below, a third-party payor exception may be addressed. In one embodiment, these actions are executed after the prescription moves from the triage queue and before the prescription moves to the “production queue” 104 for processing (i.e., filling) of the order. The present invention is not limited, however, to any particular order or timing of events occurring downstream of the triage queue. In various embodiments, prescriptions are filled in the order in which they are received in the production queue 104 (i.e., the production queue 104 is) or are filled based on a priority order in the production queue 104. In some embodiments of the invention, a third “verification queue” 106 is used to verify that the prescriptions were filled correctly.

An illustration of a system 200 including a more detailed example of triage queue 202 is illustrated in FIG. 2. Some of the sources of prescriptions are shown, including online sources 204 (e.g., sent over the secure Internet or other network via a web browser, email, mobile-phone application, or other application) faxes 206, a drive-through window 208, and telephone calls or voicemails from doctors 210. The present invention is not, however, limited to only these sources, and any source of prescriptions are within the scope of the current invention. As explained in greater detail below, the triage queue 202 may further be populated with prescriptions arriving from downstream points (from, e.g., a production or verification queue) known as problem/issue prescriptions 218.

The received prescriptions are entered into the triage queue 202. The prescriptions may include such information as a patient name, a drug name, a drug dosage, the prescribing doctor's address and contact information, source of the prescription (e.g., fax, voicemail, drive-through drop off), or other such information relating to the patient, drug, or prescription. Based on this information, each prescription is assigned a priority and entered into an appropriate place in the triage queue 202 (i.e., below prescriptions having a higher priority and above prescriptions having a lower priority). Note that, as referred to herein, the first (i.e., topmost) entry or entries in the triage queue 202 have highest priority and priority decreases further down the list; the present invention is not, however, limited to any particular orientation or configuration of the triage queue 202.

The priority assigned to a prescription may be any number or other method for distinguishing and comparing the order of the prescriptions. In one embodiment, the prescriptions are classified by entry number 212 and triage time 214. The entry number 212 may represent the position of each prescription in the triage queue 202; the triage time 214 may represent the time remaining until an associated prescription is to be moved out of the triage queue for downstream processing (into, e.g., the production queue 104 illustrated in FIG. 1). In one embodiment, the triage time 214 is a dynamic field that decreases with time; the first prescription in the triage queue 202 may initially have a triage time of five minutes, for example, but as time elapses, the displayed triage time 214 may decrease to four minutes, three minutes, etc. The triage queue 202 may further display a promise time 216, which is a time at which a prescription is promised to be filled and delivered to a customer. In various embodiments, the triage queue 202 displays other representations of the time remaining for each prescription in the queue 202 such as an “action time” indicating the wall-clock time at which an associated prescription is to acted upon in be the triage queue 202 (instead of, or in addition to, the triage time 214). In still other embodiments, the triage queue 202 displays a time elapsed in-queue for each item in the triage queue 202 instead of, or in addition to, an indication of the time remaining in queue (e.g., the triage time 214). In one embodiment, the items in the triage queue 202 are re-sorted continuously, at periodic intervals, and/or when a triage time 214 changes. The present invention is not limited to any particular indication of time or rank for each prescription in the triage queue 202.

Another example of a triage queue 300 is illustrated in FIG. 3. In this embodiment, the triage queue 300 includes, for each prescription entered, a line number 302, a triage time 304, a type 306, a detail 308, a patient name 310, a drug name 312, and a promise time 314. Each prescription may not have an entry for each of the fields 302-314; if a piece of information is not known, the field is left blank. The type 306 may include a classification of the prescription, such as a new prescription, an unknown prescription (i.e., no information is yet known about the prescription apart from its arrival and arrival time), a follow-up prescription, a response prescription, or any other such type. The detail 308 may include further information about the prescription, such as its intake channel (i.e., how it arrived at the pharmacy).

FIG. 4 illustrates an exemplary computing system 400 that includes a memory 402, processor 404, and storage device 406 for implementing embodiments of the current invention. The memory 402 may be RAM, ROM, flash, or any other type of volatile memory; the processor 404 may be a microprocessor or similar device; and the storage device may be a magnetic disk, solid-state disk, optical drive, or any other type of non-volatile computer memory; the storage device may contain, for example, information related to drug types and classifications. The system 400 may further include input/output device(s) 408, which may include monitors, keyboard, mice, touchscreens, scanners, fax machines, or any other type of computer input/output device. A network link 410 may be used to connect the system 400 to a network, such as a company intranet or the Internet, and may include a wireless or wired network interface and/or phone/fax interface. The system 400 is shown as an example only; one of skill in the art will understand that other configurations of computing system are possible and are within the scope of the present invention.

The memory 402 may include one or more software modules and/or data structures, such as a triage queue 412, a production queue 414, a verification queue 416, and a queue manager 418; some or all of these modules or structures may additionally or alternatively stored on the storage device 406. The modules and structures may be programmed in any computer language known in the art, such as C or JAVA. One of skill in the art will understand that the modules and structures are shown as their depicted separate entities for illustrative purposes only, and that other embodiments of the invention may combine or separate the modules and structures in ways that are within the scope of the present invention.

The input/output device(s) 408 and network 410 may be used to receive new prescriptions automatically (i.e., without human interaction), manually (i.e., with human interaction) or any combination of the two. For example, if a customer or doctor places an order online, it may be received at the network 410 and entered into the triage queue 412 by the queue manager 418 automatically. If a prescription is received via fax, system 400 may scan the fax (using, for example, optical-character recognition) to first identify whether the fax is indeed a prescription (by, e.g., identifying keywords or identifiers in the fax) and, if so, identify the patient name, drug type, and other information; in other embodiments, only the arrival time of the fax is noted and the prescription is entered into the triage queue 412 without further information. Similarly, a voicemail describing a prescription may be analyzed with a speech-to-text program for the prescription details and thereafter entered into the triage queue 412. In one embodiment, a technician verifies or completes the prescription details determined by the system 400. Other sources of prescriptions, such as a telephone call from a prescribing physician, are entered manually into the triage queue 412.

With reference again also to FIGS. 2 and 3, in one embodiment, the system 400 assigns prescriptions arriving in the triage queue 300 a promise time 314 (i.e., a time at which the prescription should be filled and ready for pick-up by a customer) and a triage time 304 (i.e., a time at which an appropriate action should be taken to move the prescription forward in the workflow. As the term is used herein, the “workflow” refers to, in general, the steps taken from receiving a new prescription to filling the prescription and otherwise preparing the prescription for pick-up by a customer. Specifically, the workflow refers to the steps represented by the queues illustrated in FIG. 1 and associated actions. In one embodiment, the triage time 304 refers to the time at which the prescription leaves the triage queue 300 based on one or more factors. In one embodiment, the promise time 314 may be provided by an external source or input, such as by the customer or by a prescribing doctor. In this embodiment, the provided promise time 314 is entered into the triage queue 300.

No promise time may be provided, however; in this case, the system 400 may compute a promise time 314. In one embodiment, the promise time 314 is computed based on a type and/or quantity of the drug indicated in a prescription. A drug may be identified as “acute,” for example, if it is associated with the treatment of an acute disease or injury. In this case, a shorter promise time 314 (e.g., thirty minutes from the current time) may be assigned to the associated prescription. Drugs may be alternatively classified as “maintenance” if, for example, they are associated with non-acute diseases or injuries and/or if the prescription is a refill renewal of an existing, expired order which was authorized by a prescriber. In this case, the prescription may be assigned a longer promise time 314 (e.g., two hours from the current time). Further classifications of prescriptions and further levels of associated promise times 314 are within the scope of the present invention. In one embodiment, a computed promise time 314 overwrites a supplied promise time 314 if the computed promise time 314 is shorter.

Some prescriptions may have defined a controlled cadence for contacting a prescriber for authorization to refill a prescribed prescriptions (at, for example, a customer's request). In these cases, the promise time 314 for sending such a request is set to a predetermined time in the future (e.g., two business days). The system 400 places the prescription into the appropriate queue to request an authorization from a prescriber. The system may retry the prescriber in accordance with the predetermined cadence. If, after a set number of attempts to the prescriber, the prescription renewal has not been resolved, the system may prompt a team member in the appropriate queue at a given time before the promise time (e.g., 90 minutes). If the issue cannot be resolved, the system may prompt the technician or pharmacist to contact the customer associated with the prescription and set a new promise time (or to leave a message with the new promise time if the customer is unavailable). In one embodiment, the triage time 304 is set to be this same value (e.g., 90 minutes).

In one embodiment, a drug type of a prescription is not known, and the prescription has no given promise time. In this embodiment, the system 400 sets the promise time to a default value. This value may be based on the time given an “acute” prescription—i.e., in the absence of knowing the prescription type, the system 400 assumes it is acute. In other embodiments, the system 400 assigns different promise times to unknown prescriptions, such as the promise time given to maintenance prescriptions or a time in between that given to acute and maintenance prescriptions. Once the drug type is determined (by a data-entry technician, as explained further below) the promise time 314 may be adjusted; for example, if the drug is recognized as a maintenance drug, the promise time 314 may be increased from that of an acute drug to that of a maintenance drug. In another embodiment, the proximity of a customer to a pick-up location is used to compute or adjust the promise time 314 and/or triage time. If the location of the customer is known (via, for example, a location reported from a mobile device, derived from a home phone number used to convey prescription information, as reported by the customer, or as determined by a pharmacy employee), the promise time 314 and/or triage time may be decreased (for customers nearby a pick-up location) or increased (for customers far from a pick-up location). In yet another embodiment, the proximity of a prescribing entity (e.g., a clinic, doctor's office, or other such entity) to the receiving pharmacy is used to compute or adjust the promise time 314 and/or triage time. If the prescribing entity is near (e.g., within a mile or even within the same building), the promise time 314 and/or triage time may be decreased; if far, increased).

The triage time 304 may be assigned as a function of the promise time 314. In one embodiment, the triage time 304 is computed as halfway between the current time and the promise time 314 associated with a prescription; this triage time 304 may be given to acute (or otherwise higher-priority) prescriptions. In one embodiment, the triage time 304 is a function of the promise time and the “slotting time” (the time at which the prescription is entered into the triage queue 412. In further embodiments, the computed triage times 304 may further depend on other variables, such as the staffing level of the pharmacy, the number of entries in the triage queue 412, the time of day, a pill or dosage count of a prescription, or other similar variables. The maximum triage time 412 may be capped at a certain time (e.g., four hours). A minimum triage time 412 may also be set; if a promise time is less than a certain number of minutes from a current time (e.g., 30 minutes), the triage time 412 may be set to zero (i.e., due immediately).

As described above, once assigned, the system 400 updates the triage time as time passes; when the triage time falls to zero, the associated prescriptions become due and are prioritized to the top of the triage queue 412. In one embodiment, if the prescription details are complete (i.e., the patient name, drug type, drug dose, and/or related information are known), the queue manager 418 moves the due prescriptions to the production queue 414 automatically. For incomplete prescriptions, a data-entry technician may examine the information received regarding the prescription (e.g., a fax, voicemail, paper prescription, or other such piece of information) and enter further information into the system 400 and/or perform other activities to thereby allow the system 400 to move the associated prescriptions to the production queue 414. In other embodiments, the data-entry technician informs the system 400 to move all of the due prescriptions in the triage queue 412 (i.e., no prescriptions are automatically moved by the system 400).

In some embodiments, more than one prescription in the triage queue 412 is due at the same time. FIG. 5 illustrates a triage queue 500 in which the first four prescriptions 1, 2, 3, 4 have become due as indicated by their triage times 502. In one embodiment, these due prescriptions are processed in their original order (i.e., the order in which they became due). In other embodiments, the due prescriptions are re-ordered in accordance with their classification, type 403, or other characteristic. For example, if a prescription associated with a customer waiting at a drive-through window becomes due, it is moved to the first, highest-priority position in the triage queue 500, even if other prescriptions have already become due. In various embodiments, followed by due prescriptions having promise times assigned (by, e.g., customers or doctors), followed by acute prescriptions, followed by any other prescriptions. In one embodiment, the group of prescriptions assigned promise times are re-ordered within that group: drive-through orders may be prioritized before or after in-clinic orders, for example. Any due prescriptions in the triage queue 500 may be re-ordered each time a new prescription becomes due.

Prescriptions leaving the triage queue 412 enter the production queue 414. In some embodiments, prescriptions may also enter the production queue 414 via other means; a prescription received from an in-store customer, for example, may be placed in the production queue 414 directly (by, e.g., a data-entry technician). Prescription refills (received via, for example, an interactive voice-response system or an automated refill system) may similarly be placed directly into the production queue 414. The present invention is not, however, limited to any particular combinations or configurations of different types of prescriptions to be placed in the triage queue 412 or directly into the production queue 414.

Prescriptions in the production queue 414 may filled by, for example, a technician or pharmacist in any suitable order. In one embodiment, prescriptions in the production queue are filled (or otherwise similarly processed) in the order they arrive. In another embodiment, high-priority prescriptions in the triage queue 412 are granted a high priority in the production queue 414. Once filled (or designated to be filled), the prescriptions may be placed in a verification queue 416 for verification by a pharmacist or other qualified person. In one embodiment, the qualification is granted by a federal or state agency. Like the production queue 414, prescriptions in the verification queue 416 may be processed in the order in which they are placed in the queue 416.

As described briefly above, an incoming prescription may have an issue that prevents the system 400 from moving the item forward in the workflow (e.g., from the triage queue to the production queue). For example, the pharmacy at which the prescription is received may be out of stock of a drug required by the prescription. In this case, the out-of-stock condition is discovered when the prescription is acted upon on or enters the triage queue 412 by, for example, a data-entry technician monitoring the queue 412. The timing of the resolution of the out-of-stock condition is thus set by the triage time and/or promise time set for the prescription; higher-priority prescriptions having an out-of-stock issue are discovered and attended to earlier than a similar low-priority prescription. In this way, the triage queue 412 schedules the resolution of the out-of-stock condition in accordance with the priority of the prescription, thus permitting the technician and system 400 to attend to other high-priority prescriptions in lieu of a low-priority out-of-stock condition. In one embodiment, when a prescription having an out-of-stock condition comes due, the system 400 prompts the technician to contact the customer associated with the prescription and set a new promise time (or leave a message with a new promise time if the customer is unavailable). When the new promise time is obtained, the technician reschedules the prescription in the system.

Other incoming prescriptions may require confirmation, clarification, or correction from a third party, such as the prescribing doctor, before they may be filled. Again, as with out-of-stock issues, the timing of the resolution of a third-party issue associated with a prescription is managed along with the rest of the prescriptions in the triage queue 412, thus freeing pharmacy staff from, for example, unnecessarily prioritizing a third-party issue over other, higher-priority prescriptions. Once a prescription having a third-party issue becomes high-priority (e.g., at the top of the triage queue 412) in the triage queue 412, a technician or pharmacist may attempt to contact the third party. If the issue can be resolved (e.g., the third party provides the necessary information and/or approval), the technician may update the prescription and move the prescription to the triage queue 412 or production queue 414. If the issue cannot be resolved (if, e.g., the third party cannot be reached), the technician may flag the prescription with an “exception” or similar flag, and it may re-enter the triage queue for prioritization. Thus flagged, the prescription is not eligible for entry into the production queue, but may be later re-visited for one or more follow-up third-party contact attempts. For example, a technician may be prompted by the system 400 to contact the customer associated to the prescription and set a new promise time, leave a message, or update the information and move the item forward in workflow to the production queue 414. After a certain number of such attempts (e.g., three), the requesting customer may be contacted and required to follow-up with the third party (and the prescription may be flagged accordingly).

In one embodiment, the system prioritizes non-prescription filling work (i.e., tasks not associated with an incoming prescription) along with prescription filling work to thereby remind or notify technicians and pharmacists of the appropriate time to act upon such non-prescription filling work (e.g., visibility to prescriber voicemails, follow-up calls to prescribers, or patient calls). These non-prescription items may be prioritized immediately under the urgent work and above any non-urgent work. For example, the system 400 may send a request to a prescriber for a prescription refill. If a response has not been received in a certain amount of time (e.g., ten hours), the refill request may be entered into the verification queue 416 with instructions for a pharmacist to call the prescriber. If the prescriber cannot be reached, an item may be placed in the triage queue 412 with instructions for a technician to contact the associated customer to so inform him or her.

FIG. 6 illustrates an embodiment 600 of the triage and production queues described above in a pharmacy. A queue server 602 implements the functionality of the queue system described above (e.g., the system 400 illustrated in FIG. 4); a number of other in-store device may be used with the queue server 602. For example, a drive-through terminal 604 may be used by a drive-through technician to enter received prescriptions into the triage queue; likewise, a similar in-store terminal 608 may be used at an in-store counter for the same purpose. A fax machine/phone 606 may be used to receive faxed or called-in prescriptions for entry into the triage queue. A production terminal 610 may be used to move prescriptions from the triage queue or a production queue; this or a similar terminal or terminals may be used by a technician for reading and filling prescriptions from the production queue. A verification terminal 612 may be used by a pharmacist to verify the filled prescriptions.

Each of the terminals 604, 608, 610, 612 described above may be personal computers (i.e., desktops), laptop computers, tablet computers, handheld computers (e.g., smartphones) or any such similar devices. The terminals 604, 608, 610, 612 may be linked to the server 602 via wired or wireless connections. The server 602 may be on-site (i.e., in the pharmacy) or wholly or partially remotely located; the terminals may therefore communicate therewith via a wide-area connection such as an intranet or the Internet. The present invention is not, however limited to any particular number or configuration of terminals or servers.

It should also be noted that embodiments of the present invention may be provided as one or more computer-readable programs embodied on or in one or more articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. Some examples of languages that may be used include C, C++, or JAVA. The software programs may be further translated into machine language or virtual machine instructions and stored in a program file in that form. The program file may then be stored on or in one or more of the articles of manufacture.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A method for managing workflow in a pharmacy, the method comprising:
receiving electronic data comprising a pharmaceutical prescription;
storing the electronic data in a computer memory;
assigning to the received pharmaceutical prescription, based on the electronic data, (i) a priority and (ii) a time at which the prescription is to be filled;
selecting a prescription having the highest priority from a plurality of prescriptions; and
indicating, to a user, via an electronic display, that the selected prescription is to be filled by the time.

2. The method of claim 1, wherein the electronic data comprises an online data transmission, fax, or voicemail.

3. The method of claim 1, wherein selecting the prescription comprises entering the received prescription into a triage queue comprising other prescriptions.

4. The method of claim 1, wherein assigning the time comprises computing the time based on a type of drug indicated in the prescription.

5. The method of claim 4, wherein the drugs are typed as acute or maintenance, and wherein acute drugs have a time occurring earlier than maintenance drugs.

6. The method of claim 1, wherein assigning the time comprises computing the time based on a channel from which the prescription was received.

7. The method of claim 1, wherein assigning the time comprises applying a time communicated from a customer or third party.

8. The method of claim 1, further comprising receiving prescriptions from in-store drop-off, drive-through drop-off, or a prescriber telephone call.

9. The method of claim 1, wherein the selected prescription comprises an issue preventing its filling and is assigned a new priority or time.

10. A system for managing workflow in a pharmacy, the system comprising:
an input port for receiving data comprising a pharmaceutical prescription;
a processor for executing instructions stored in a computer memory, the computer memory comprising:
i. a queue manager module for assigning to the prescription, based on the received data, (i) a priority and (ii) a time at which the prescription is to be filled;
ii. a triage queue for storing a plurality of pending prescriptions each having a priority and a time at which it is to be filled;
iii. a production queue for receiving, from the triage queue, a highest-priority prescription; and
a computer display for indicating, to a user, that the received prescription is to be filled by its assigned time.

11. The system of claim 10, wherein the computer memory further comprises a verification queue for indicating which of a plurality of filled prescriptions is to be verified for correctness.

12. The system of claim 10, further comprising a terminal for entering the data comprising the prescription.

13. The system of claim 10, wherein the priority queue comprises a triage time indicating a time at which the prescription leaves the triage queue.

14. The system of claim 10, wherein assigning the time comprises computing the time based on a type of drug indicated in the prescription.

15. The system of claim 14, wherein the drugs are typed as acute or maintenance, and wherein acute drugs have a time occurring earlier than maintenance drugs.

16. The system of claim 14, further comprising a storage device for storing information related to the types of drugs.
